(19) United States
(12) Patent Application Publication
(10) Pub. No.: US 2026/0189432 A1
(43) Pub. Date: Jul. 2, 2026

(54) CHANNEL ESTIMATION METHOD AND APPARATUS

(71) Applicant: HUAWEI TECHNOLOGIES CO., LTD., Shenzhen (CN)

(72) Inventors: Yisheng Jiang, Shanghai (CN); Xiaoyan Bi, Shanghai (CN); Chenglong Jiang, Shanghai (CN); Yong Liu, Shanghai (CN); Lei Liu, Shanghai (CN)

(21) Appl. No.: 19/551,806

(22) Filed: Feb. 27, 2026

Related U.S. Application Data
(63) Continuation of application No. PCT/CN2023/116300, filed on Aug. 31, 2023.

(51) Int. Cl. H04L 25/02; H04L 5/00

(52) U.S. Cl. CPC H04L 25/0202; H04L 5/0005

(57) ABSTRACT

According to a channel estimation method, a first communication apparatus receives a reference signal, and determines at least two channel vectors based on the reference signal, where the at least two channel vectors include channel vectors s₀ and s₁. The first communication apparatus receives assistance information for channel estimation from a second communication apparatus, where the assistance information includes channel interpolation parameter information of the channel vectors s₀ and s₁. The first communication apparatus performs channel estimation based on the channel interpolation parameter information. To prevent degradation in channel estimation performance caused by a receiver's limited ability to calculate a channel interpolation-related parameter in a channel estimation process, a transmitter calculates channel interpolation parameter-related information and sends the channel interpolation parameter-related information to the receiver machine.

### CROSS-REFERENCE TO RELATED APPLICATIONS

This application is a continuation of International Application No. PCT/CN2023/116300, filed on Aug. 31, 2023, the disclosure of which is hereby incorporated by reference in its entirety.

### TECHNICAL FIELD

This application relates to the field of communication technologies, and in particular, to a channel estimation method and an apparatus.

### BACKGROUND

In a massive multiple-input multiple-output (MIMO) system, channel estimation plays an important role because system performance is highly dependent on quality of channel information obtained by the system. Channel estimation is a process of reconstructing or restoring a received signal to compensate for signal distortion caused by channel fading and noise, where changes in a time domain and a frequency domain of a channel are tracked by using a standard signal predicted by a transmitter machine and a receiver machine. In an actual system, auxiliary pilot-based channel estimation is a common channel estimation method, where the transmitter machine periodically sends pilot signals, and the receiver machine obtains channel state information (CSI) based on the received pilot signals. The standard signal is also referred to as a pilot signal or a reference signal (RS). Standard signals are distributed on different resource elements (RE) in time-frequency two-dimensional space in an orthogonal frequency division multiplexing (OFDM) symbol, and have a known amplitude and phase.

In the massive MIMO system, time-frequency resource sparsification of the reference signal is one of main approaches to implement a larger quantity of transmission streams. When a quantity of parallel transmission streams increases, a quantity of orthogonal ports also increases. If total RS overheads remain unchanged, time-frequency domain density of the RS decreases as the quantity of orthogonal ports increases. Consequently, when the receiver machine performs channel estimation, sampling density increases, and spectral efficiency of MIMO transmission decreases.

Therefore, when a quantity of transmission streams increases, to improve spectral efficiency, a manifold-based channel estimation method may be used to perform channel estimation. When the receiver machine performs channel estimation by using the method, channel interpolation-related parameters need to be calculated. However, the receiver machine may be affected by factors such as a signal-to-noise ratio and channel non-ideality when calculating the channel interpolation-related parameters. This reduces accuracy of channel estimation, affects data demodulation effect, and further reduces spectral efficiency of the MIMO system. In addition, the receiver machine may have a problem of insufficient computational power.

### SUMMARY

This application provides a channel estimation method and an apparatus. To improve channel estimation performance caused by a receiver's limited ability to calculate a channel interpolation-related parameter in a channel estimation process, a transmitter machine calculates channel interpolation parameter-related information and sends the channel interpolation parameter-related information to the receiver machine. This improves channel estimation performance, improves data demodulation effect, and improves spectral efficiency of a MIMO system.

According to a first aspect, a channel estimation method is provided. The method may be performed by a communication apparatus, or may be performed by a chip or a circuit disposed in the communication apparatus. This is not limited in this application.

The method includes: A first communication apparatus receives a reference signal. The first communication apparatus determines at least two channel vectors based on the reference signal, where the at least two channel vectors include channel vectors s₀ and s₁. The first communication apparatus receives assistant information of channel estimation from a second communication apparatus, where the assistant information of channel estimation includes channel interpolation parameter information of the channel vectors s₀ and s₁. The first communication apparatus performs channel estimation based on the channel interpolation parameter information.

According to the foregoing solution, the second communication apparatus sends the calculated assistant information of channel estimation to the first communication apparatus, thereby improving precision of channel interpolation-related parameters, saving computational power of the first communication apparatus, and improving channel estimation effect.

With reference to the first aspect, in some implementations of the first aspect, the channel interpolation parameter information is vector parameters that are of the channel vectors s₀ and s₁ and that are related to a port and a frequency domain location of the reference signal, or the channel interpolation parameter information is vector parameters that are of the channel vectors s₀ and s₁ and that are related to a port and a time domain location of the reference signal.

In an example embodiment, the channel interpolation parameter information includes at least one of the following parameters: an included angle θ between the channel vectors s₀ and s₁, a propagation rotation included angle φ between the channel vectors s₀ and s₁, and one or more to-be-interpolated channel vector locations t.

θ and φ are determined according to the following relational expressions:

$$θ = a cos ( \vert {s}_{0}^{H} {s}_{1} \vert )$$

$$ϕ = a tan ( \frac{Im ( {s}_{0}^{H} {s}_{1} )}{Re ( {s}_{0}^{H} {s}_{1} )} )$$

Re(x) represents a real part of a complex number x, and Im(x) represents an imaginary part of the complex number x. acos(x) represents an arc cosine of x, and atan(x) represents an arc tangent of x.

In another example embodiment, the channel interpolation parameter information is determined based on parameters θ and φ, or the channel interpolation parameter information is determined based on parameters θ, φ, and t, where θ is an included angle between the channel vectors s₀ and s₁, φ is a propagation rotation included angle between the channel vectors s₀ and s₁, and t is one or more to-be-interpolated channel vector locations.

For example, the channel interpolation parameter information includes at least one of parameters α and β, and α and β are determined according to the following relational expressions:

$$α = ( cos ( t \cdot θ ) - cos ( θ ) \cdot \frac{sin ( t \cdot θ )}{sin ( θ )} ) \cdot {e}^{+ j ϕ \cdot t}$$

$$β = \frac{sin ( t \cdot θ )}{sin ( θ )} \cdot {e}^{+ j ϕ \cdot ( t - 1 )}$$

In an example embodiment, the channel vector location t is a location of one or more to-be-interpolated subcarriers in a frequency domain.

In an example embodiment, the channel vector location t is a sequence number of the one or more to-be-interpolated subcarriers.

In an example embodiment, the channel vector location t is a location of one or more to-be-interpolated signals in a time domain.

In an example embodiment, the subcarrier location t is a sequence number of an orthogonal frequency division multiplexing symbol OFDM symbol of the one or more to-be-interpolated signals.

In an example embodiment, before the first communication apparatus receives the reference signal, the first communication apparatus sends channel estimation capability information, where the channel estimation capability information indicates a channel estimation capability of the first communication apparatus.

According to a second aspect, a channel estimation method is provided. The method may be performed by a communication apparatus, or may be performed by a chip or a circuit disposed in the communication apparatus. This is not limited in this application.

The method includes: A second communication apparatus sends a reference signal to a first communication apparatus, where the reference signal is used to determine at least two channel vectors, and the at least two channel vectors include channel vectors s₀ and s₁. The second communication apparatus determines assistant information of channel estimation, where the assistant information of channel estimation is used for channel estimation of the first communication apparatus, and the assistant information of channel estimation includes channel interpolation parameter information of the channel vectors s₀ and s₁. The second communication apparatus sends the assistant information of channel estimation to the first communication apparatus.

According to the foregoing solution, the second communication apparatus sends the calculated assistant information of channel estimation to the first communication apparatus, thereby improving precision of channel interpolation-related parameters, saving computational power of the first communication apparatus, and improving channel estimation effect.

With reference to the second aspect, in some example embodiments of the second aspect, the channel interpolation parameter information is vector parameters that are of the channel vectors s₀ and s₁ and that are related to a port and a frequency domain location of the reference signal, or the channel interpolation parameter information is vector parameters that are of the channel vectors s₀ and s₁ and that are related to a port and a time domain location of the reference signal.

In an example embodiment, that the second communication apparatus determines the assistant information of channel estimation includes: The second communication apparatus determines the channel interpolation parameter information, where the channel interpolation parameter information includes at least one of the following parameters: an included angle θ between the channel vectors s₀ and s₁, a propagation rotation included angle φ between the channel vectors s₀ and s₁, and one or more to-be-interpolated channel vector locations t.

θ and φ are determined according to the following relational expressions:

$$θ = a cos ( \vert {s}_{0}^{H} {s}_{1} \vert )$$

$$ϕ = a tan ( \frac{Im ( {s}_{0}^{H} {s}_{1} )}{Re ( {s}_{0}^{H} {s}_{1} )} )$$

Re(x) represents a real part of a complex number x, and Im(x) represents an imaginary part of the complex number x. acos(x) represents an arc cosine of x, and atan(x) represents an arc tangent of x.

In another possible implementation, that the second communication apparatus determines the assistant information of channel estimation includes: The second communication apparatus determines the channel interpolation parameter information, where the channel interpolation parameter information is determined based on parameters θ and φ, or the channel interpolation parameter information is determined based on parameters θ, φ, and t, where θ is an included angle between the channel vectors s₀ and s₁, φ is a propagation rotation included angle between the channel vectors s₀ and s₁, and t is one or more to-be-interpolated channel vector locations.

For example, the channel interpolation parameter information includes at least one of parameters α and β, and α and β are determined according to the following relational expressions:

$$α = ( cos ( t \cdot θ ) - cos ( θ ) \cdot \frac{sin ( t \cdot θ )}{sin ( θ )} ) \cdot {e}^{+ j ϕ \cdot t}$$

$$β = \frac{sin ( t \cdot θ )}{sin ( θ )} \cdot {e}^{+ j ϕ \cdot ( t - 1 )}$$

In an example embodiment, the channel vector location t is a location of one or more to-be-interpolated subcarriers in a frequency domain.

In an example embodiment, the channel vector location t is a sequence number of the one or more to-be-interpolated subcarriers.

In an example embodiment, the channel vector location t is a location of one or more to-be-interpolated signals in a time domain.

In an example embodiment, the subcarrier location t is a sequence number of an orthogonal frequency division multiplexing symbol OFDM symbol of the one or more to-be-interpolated signals.

In an example embodiment, before the second communication apparatus sends the reference signal to the first communication apparatus, the second communication apparatus receives channel estimation capability information, where the channel estimation capability information indicates a channel estimation capability of the first communication apparatus.

According to a third aspect, a channel estimation apparatus is provided, including a receiving unit and a processing unit. The receiving unit is configured to receive a reference signal, where the reference signal is used to determine at least two channel vectors, and the at least two channel vectors include channel vectors s₀ and s₁. The receiving unit is further configured to receive assistant information of channel estimation, where the assistant information of channel estimation includes channel interpolation parameter information of the channel vectors s₀ and s₁. The processing unit is configured to determine the channel vector based on the reference signal and/or perform channel estimation based on the channel interpolation parameter information.

With reference to the third aspect, in some example embodiments of the third aspect, the channel interpolation parameter information is vector parameters that are of the channel vectors s₀ and s₁ and that are related to a port and a frequency domain location of the reference signal, or the channel interpolation parameter information is vector parameters that are of the channel vectors s₀ and s₁ and that are related to a port and a time domain location of the reference signal.

In an example embodiment, the channel interpolation parameter information includes at least one of the following parameters: an included angle θ between the channel vectors s₀ and s₁, a propagation rotation included angle φ between the channel vectors s₀ and s₁, and one or more to-be-interpolated channel vector locations t.

In another example embodiment, the channel interpolation parameter information is determined based on parameters θ and φ, or the channel interpolation parameter information is determined based on parameters θ, φ, and t, where θ is an included angle between the channel vectors s₀ and s₁, φ is a propagation rotation included angle between the channel vectors s₀ and s₁, and t is one or more to-be-interpolated channel vector locations.

In an example embodiment, the channel vector location t is a location of one or more to-be-interpolated subcarriers in a frequency domain.

In an example embodiment, the channel vector location t is a sequence number of the one or more to-be-interpolated subcarriers.

In an example embodiment, the channel vector location t is a location of one or more to-be-interpolated signals in a time domain.

In an example embodiment, the subcarrier location t is a sequence number of an orthogonal frequency division multiplexing symbol OFDM symbol of the one or more to-be-interpolated signals.

In an example embodiment, the apparatus further includes a sending unit, configured to send channel estimation capability information, where the channel estimation capability information indicates a channel estimation capability of a first communication apparatus.

According to a fourth aspect, a channel estimation apparatus is provided, including: a sending unit, configured to send a reference signal to a first communication apparatus, where the reference signal is used to determine at least two channel vectors, and the at least two channel vectors include channel vectors s₀ and s₁; and a processing unit, configured to determine assistant information of channel estimation, where the assistant information of channel estimation is used for channel estimation of the first communication apparatus, and the assistant information of channel estimation includes channel interpolation parameter information of the channel vectors s₀ and s₁. The sending unit is further configured to send the assistant information of channel estimation to the first communication apparatus.

With reference to the fourth aspect, in some example embodiments of the fourth aspect, the channel interpolation parameter information is vector parameters that are of the channel vectors s₀ and s₁ and that are related to a port and a frequency domain location of the reference signal, or the channel interpolation parameter information is vector parameters that are of the channel vectors s₀ and s₁ and that are related to a port and a time domain location of the reference signal.

In an example embodiment, the processing unit is further configured to determine the channel interpolation parameter information, where the channel interpolation parameter information includes at least one of the following parameters: an included angle θ between the channel vectors s₀ and s₁, a propagation rotation included angle φ between the channel vectors s₀ and s₁, and one or more to-be-interpolated channel vector locations t.

In another example embodiment, the processing unit is further configured to determine the channel interpolation parameter information, where the channel interpolation parameter information is determined based on parameters θ and φ, or the channel interpolation parameter information is determined based on parameters θ, φ, and t, where θ is an included angle between the channel vectors s₀ and s₁, φ is a propagation rotation included angle between the channel vectors s₀ and s₁, and t is one or more to-be-interpolated channel vector locations.

In an example embodiment, the channel vector location t is a location of one or more to-be-interpolated subcarriers in a frequency domain.

In an example embodiment, the channel vector location t is a sequence number of the one or more to-be-interpolated subcarriers.

In an example embodiment, the channel vector location t is a location of one or more to-be-interpolated signals in a time domain.

In an example embodiment, the subcarrier location t is a sequence number of an orthogonal frequency division multiplexing symbol OFDM symbol of the one or more to-be-interpolated signals.

In an example embodiment, the apparatus further includes a receiving unit, configured to receive channel estimation capability information, where the channel estimation capability information indicates a channel estimation capability of the first communication apparatus.

According to a fifth aspect, a wireless communication apparatus is provided, including modules or units configured to perform the method in any one of the first aspect or the example embodiments of the first aspect.

According to a sixth aspect, a wireless communication apparatus is provided, including modules or units configured to perform the method in any one of the second aspect or the example embodiments of the second aspect.

According to a seventh aspect, a communication device is provided, including a processor. The processor is coupled to a memory, and may be configured to perform the method in the first aspect and the example embodiments of the first aspect or the second aspect and the example embodiments of the second aspect. In an example embodiment, the communication device further includes the memory. In an example embodiment, the communication device further includes a communication interface, and the processor is coupled to the communication interface.

In an implementation, the communication device is a terminal device. When the communication device is a terminal device, the communication interface may be a transceiver or an input/output interface. In an example embodiment, a transceiver may be a transceiver circuit. In an example embodiment, an input/output interface may be an input/output circuit.

In another implementation, the communication device is a network device. When the communication device is a network device, the communication interface may be a transceiver or an input/output interface. In an example embodiment, a transceiver may be a transceiver circuit. In an example embodiment, an input/output interface may be an input/output circuit.

In another implementation, the communication device is a chip or a chip system. When the communication device is a chip or a chip system, the communication interface may be an input/output interface, an interface circuit, an output circuit, an input circuit, a pin, a related circuit, or the like on the chip or the chip system. The processor may alternatively be embodied as a processing circuit or a logic circuit.

According to an eighth aspect, a communication apparatus is provided, including an input circuit, an output circuit, and a processing circuit. The processing circuit is configured to receive a signal through the input circuit, and transmit a signal through the output circuit, so that the method in either the first aspect or the second aspect and any one of the example embodiments of the foregoing aspects is implemented.

In a specific implementation process, the communication apparatus may be a chip, the input circuit may be an input pin, the output circuit may be an output pin, and the processing circuit may be a transistor, a gate circuit, a trigger, various logic circuits, or the like. An input signal received by the input circuit may be received and input by, for example without limitation to, a receiver, and a signal output by the output circuit may be output to and transmitted by, for example without limitation to, a transmitter. In addition, the input circuit and the output circuit may be different circuits or may be a same circuit. In this case, the circuit is used as the input circuit and the output circuit at different moments. Specific implementations of the processor and the various circuits are not limited in embodiments of this application.

According to a ninth aspect, a processing apparatus is provided, including a processor and a memory. The processor is configured to: read instructions stored in the memory, receive a signal via a receiver, and transmit a signal via a transmitter, to perform the method in either the first aspect or the second aspect and any one of the example embodiments of the foregoing aspects.

In an example embodiment, there are one or more processors and one or more memories.

In an example embodiment, the memory and the processor may be integrated together, or the memory and the processor are disposed separately.

In a specific implementation process, the memory may be a non-transitory (non-transitory) memory, for example, a read-only memory (ROM). The memory and the processor may be integrated into a same chip, or may be separately disposed in different chips. A type of the memory and a manner in which the memory and the processor are disposed are not limited in embodiments of this application.

It should be understood that, a related data exchange process such as sending of indication information may be a process of outputting the indication information from the processor, and receiving of capability information may be a process of receiving the input capability information by the processor. Specifically, data output by the processor may be output to the transmitter, and input data received by the processor may be from the receiver. The transmitter and the receiver may be collectively referred to as a transceiver.

The processor in the foregoing aspect may be a chip, and the processor may be implemented by hardware or software. When the hardware is used for implementation, the processor may be a logic circuit, an integrated circuit, or the like. When the software is used for implementation, the processor may be a general-purpose processor, and is implemented by reading software code stored in the memory. The memory may be integrated into the processor, or may be located outside the processor, and exist independently.

According to a tenth aspect, a computer program product is provided. The computer program product includes a computer program (which may also be referred to as code or instructions). When the computer program is run, a computer is enabled to perform the method in either the first aspect or the second aspect and any one of the example embodiments of the foregoing aspects.

According to an eleventh aspect, a computer-readable medium is provided. The computer-readable medium stores a computer program (which may also be referred to as code or instructions). When the computer program is run on a computer, the computer is enabled to perform the method in either the first aspect or the second aspect and any one of the example embodiments of the foregoing aspects.

According to a twelfth aspect, a chip system is provided, including a memory and a processor. The memory is configured to store a computer program, and the processor is configured to invoke the computer program from the memory and run the computer program, so that a communication device on which the chip system is installed performs the method in either the first aspect or the second aspect and any one of the example embodiments of the first aspect and the second aspect.

The chip system may include an input circuit or interface configured to send information or data, and an output circuit or interface configured to receive information or data.

According to a thirteenth aspect, a communication system is provided, including at least one of the second communication apparatus and the first communication apparatus.

### BRIEF DESCRIPTION OF DRAWINGS

FIG. 1 is a diagram of an example of a communication system to which this application is applicable;

FIG. 2 is a schematic flowchart of an example of a channel estimation method according to an embodiment of this application;

FIG. 3 is a schematic flowchart of an example channel estimation method according to an embodiment of this application;

FIG. 4 is a diagram of an example channel according to an embodiment of this application;

FIG. 5 is a diagram of another example channel according to an embodiment of this application;

FIG. 6 is a diagram of still another example channel according to an embodiment of this application;

FIG. 7 is a block diagram of an example communication apparatus according to an embodiment of this application;

FIG. 8 is a block diagram of another example communication apparatus according to an embodiment of this application;

FIG. 9 is a block diagram of an example terminal device according to an embodiment of this application; and

FIG. 10 is a block diagram of an example network device according to an embodiment of this application.

### DESCRIPTION OF EMBODIMENTS

The following describes technical solutions of this application with reference to accompanying drawings.

The technical solutions in embodiments of this application may be applied to various communication systems, for example, a global system for mobile communications (GSM) system, a code division multiple access (CDMA) system, a wideband code division multiple access (WCDMA) system, a general packet radio service (GPRS) system, a long term evolution (LTE) system, an LTE frequency division duplex (FDD) system, an LTE time division duplex TDD) system, a wireless fidelity (Wi-Fi) system, a device-to-device (D2D) communication system, a vehicle-to-everything (V2X) communication system, a universal mobile telecommunications system (UMTS), a worldwide interoperability for microwave access (WiMAX) communication system, a machine-to-machine (M2M) communication system, a machine type communication (MTC) system, an internet of things (IoT) communication system, a non-terrestrial network (NTN) system, a 5th generation (5G) mobile communication system, a 6th generation (6G) mobile communication system, a new radio (NR) system, or a future wireless communication system.

First, a network architecture to which this application is applicable is briefly described.

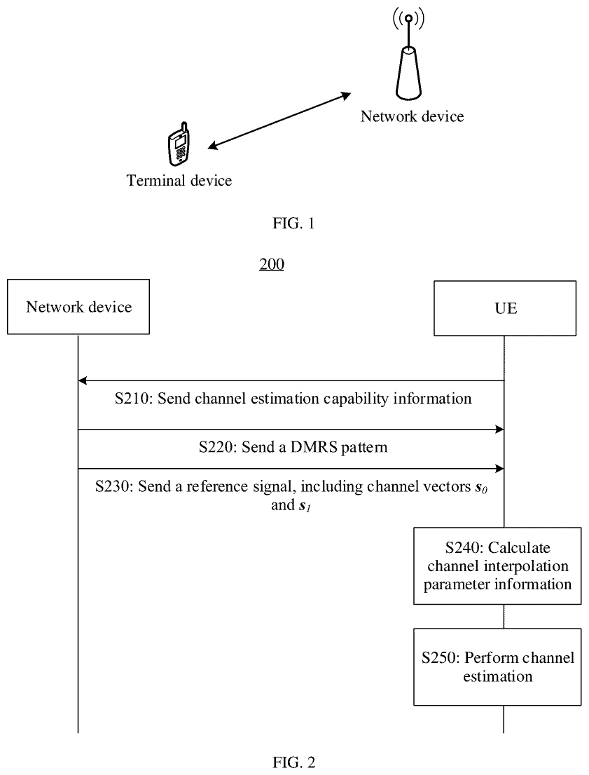

As shown in FIG. 1, the communication system may include at least one network device, for example, a network device shown in FIG. 1. The communication system may further include at least one terminal device, for example, a terminal device shown in FIG. 1. The network device may communicate with the terminal device through a radio link. In the communication system, the network device and the terminal device may perform wireless communication by using an air interface resource. The air interface resource may include at least one of a time domain resource, a frequency domain resource, a code resource, and a space resource.

It should be understood that FIG. 1 is merely a simplified diagram used as an example for ease of understanding, and the communication system may further include another network device or another terminal device that is not shown in FIG. 1.

The terminal device in embodiments of this application may also be referred to as user equipment, an access terminal, a subscriber unit, a subscriber station, a mobile station, a remote station, a remote terminal, a mobile device, a user terminal, a terminal, a wireless communication device, a user agent, or a user apparatus. The terminal device may be a cellular phone, a cordless phone, a session initiation protocol (SIP) phone, a wireless local loop (WLL) station, a personal digital assistant (PDA), a handheld device having a wireless communication function, a computing device, another processing device connected to a wireless modem, a vehicle-mounted device, a wearable device, a terminal device in a 5G network, a terminal device in a future evolved public land mobile network (PLMN), or the like. This is not limited in embodiments of this application.

The wearable device may also be referred to as a wearable intelligent device, and is a general term of wearable devices, such as glasses, gloves, watches, clothes, and shoes, that are developed by applying wearable technologies to intelligent designs of daily wear. The wearable device is a portable device that can be directly worn on a body or integrated into clothes or an accessory of a user. The wearable device is not only a hardware device, but also implements a powerful function through software support, data exchange, and cloud interaction. In a broad sense, wearable intelligent devices include full-featured and large-sized devices that can implement all or a part of functions without depending on smartphones, for example, smart watches or smart glasses, and devices that focus on only one type of application function and need to work with other devices such as smartphones, for example, various smart bands, or smart jewelry for monitoring physical signs.

In addition, the terminal device may alternatively be a terminal device in an internet of things (IoT) system. An IoT is an important part in future development of information technologies. A main technical feature of the IoT is to connect things to a network by using a communication technology, to implement an intelligent network for human-machine interconnection and thing-thing interconnection.

It should be understood that a specific form of the terminal device is not limited in this application.

The network device in embodiments of this application may alternatively be a device configured to communicate with the terminal device. The network device may be a base transceiver station (BTS) in a global system for mobile communications (GSM) or a code division multiple access (CDMA) system, a base station (NodeB, NB) in a wideband code division multiple access (WCDMA) system, an evolved NodeB (eNB or eNodeB) in an LTE system, or a radio controller in a cloud radio access network (CRAN) scenario. Alternatively, this communication apparatus may be a relay station, an access point, a vehicle-mounted device, a wearable device, a communication apparatus in a 5G network, a communication apparatus in a future evolved PLMN network, or the like. This is not limited in embodiments of this application.

It should be understood that the network device in a wireless communication system may be any device having a wireless transceiver function. The device includes but is not limited to: an evolved NodeB (eNB), a radio network controller (RNC), a road side unit (RSU), a NodeB (NB), a base station controller (BSC), a base transceiver station (BTS), a home base station (for example, a home evolved NodeB, or a home NodeB, HNB), a baseband unit (BBU), an access point (AP) in a wireless fidelity (Wi-Fi) system, a wireless relay node, a wireless backhaul node, a transmission point (TP), or a transmission reception point (TRP). Alternatively, the device may be a gNB or a transmission point (TRP or TP) in a 5G (such as NR) system, one antenna panel or a group of antenna panels (including a plurality of antenna panels) of a base station in a 5G system, or may be a network node, for example, a baseband unit (BBU) or a distributed unit (DU), that constitutes a gNB or a transmission point. Alternatively, the network device may be a network side apparatus that provides a communication service or communication control for a terminal device in vehicle-to-everything.

The network device provides a communication service for a terminal device in a cell. The terminal device in the cell communicates with the network device by using a transmission resource (for example, a frequency domain resource or a time domain resource) allocated by the network device. The cell may belong to a macro base station (for example, a macro eNB or a macro gNB).

To facilitate understanding of embodiments of this application, terms used in this application are first briefly described.

### 1. Carrier

A carrier allocated to a terminal device may be a communication frequency resource used for signal transmission. The carrier may occupy a specific bandwidth and is located in a band. An LTE system is used as an example. A maximum carrier bandwidth of LTE is 20 MHz, and may be further divided into 1.4 MHz, 3 MHz, 5 MHz, or 10 MHz. For example, a user camps on a cell whose cell ID is 0, and the cell corresponds to a carrier whose band is a band 38, center frequency is 2585 MHz, and bandwidth is 20 MHz.

### 2. Antenna Port

An antenna port is a logic concept, is a logic port used for spatial transmission, and may correspond to one or more physical antennas.

### 3. Channel

A channel is a propagation path of a radio signal from a transmit end to a receive end. Due to various environmental factors (such as a distance, a terrain, and buildings), a signal is affected by attenuation, multipath effect, interference, and the like during propagation. Channel estimation is to study the impact, so that appropriate signal processing can be performed at a receive end.

### 4. Subcarrier

In some wireless communication systems, to improve spectral efficiency, an original broadband signal is divided into a plurality of narrowband signals, and each narrowband signal is transmitted on an independent subcarrier. Each subcarrier may be considered as an independent channel. Therefore, a quantity of subcarriers actually determines a parallel transmission capability of the system.

### 5. Channel Vector

A channel vector is a mathematical tool used to describe a characteristic of a radio channel. The channel vector includes a plurality of elements, and each element corresponds to a channel response on one subcarrier. In an orthogonal frequency division multiplexing (OFDM) system, data is separately transmitted on different subcarriers. Therefore, each subcarrier may be considered as an independent channel. The channel vector is used to describe channel responses of these subcarriers. For example, if one OFDM system has N subcarriers, a corresponding channel vector is an N-dimensional vector.

Each element of the channel vector includes amplitude and phase information of a channel on a corresponding subcarrier. This is a complex description of the channel. A channel characteristic can be learned of by estimating the channel vector, to provide important information for signal processing at a receive end, for example, proper equalization processing may be performed, to reduce impact of the channel on a received signal and improve signal receiving quality.

### 6. OFDM Symbol

In an OFDM system, an OFDM symbol is a group of data transmitted on all subcarriers. That is, an OFDM symbol includes data of all subcarriers in a specific time period. The specific time period is referred to as a symbol period.

An OFDM symbol is actually a composite signal that includes information about all subcarriers. At a receive end, the OFDM symbol may be decomposed into signals of subcarriers through a fast Fourier transform (FFT) operation, and then demodulation is performed, to restore an original data stream.

### 7. Demodulation Reference Signal Pattern (DMRS Pattern)

A DMRS pattern defines distribution and locations of a DMRS in frequency and time. In 5G NR, the DMRS pattern is configured based on different application scenarios and service requirements. In 5G NR, based on different configurations, the DMRS pattern may be single-symbol or multi-symbol, and may also be static or dynamic. Due to such configuration flexibility, 5G NR can provide good performance under different channel conditions and service requirements. The DMRS pattern is very important for channel estimation and data demodulation because it directly affects demodulation quality of a signal at a receive end. Therefore, a proper configuration of the DMRS pattern is critical to optimizing performance of a communication system. Specifically, the DMRS pattern determines distribution of the DMRS in time and frequency domain, and the distribution affects quality of channel estimation and data demodulation.

A massive multiple-input multiple-output (MIMO) technology is a core enabling technology of a 5G cellular system and a continuous evolution system of the 5G cellular system. In a massive MIMO system, a base station (BS) equipped with a large quantity of antennas may simultaneously serve dozens of users on a same time and frequency resource, thereby potentially providing a huge capacity gain and significantly improving energy efficiency. The massive MIMO technology can significantly improve system capacity and plays an important role in 5G NR and 6G.

In the MIMO system, each transmit antenna (virtual antenna or physical antenna) has an independent channel. For example, in an uplink and a downlink, to implement channel quality measurement of a multi-antenna system, a plurality of pilot symbols are defined in an NR system: a channel quality measurement reference symbol (Channel State Information-Reference Signal, CSI-RS), a demodulation reference signal (DMRS), and a sounding reference signal (SRS). The DMRS is used to assist in demodulation of a physical downlink shared channel (PDSCH). The CSI-RS is used for downlink channel measurement corresponding to a physical antenna port. A receiver machine performs channel estimation on each antenna port for sending of a base station, and performs CSI feedback based on an estimation result. CSI includes related information such as a channel quality indicator (CQI), a precoding matrix indicator (PMI), a layer indicator (LI), and a rank indicator ( ). However, in an uplink channel measurement process, a BS estimates an uplink channel based on a received SRS, and may perform frequency selection resource scheduling, power control, timing estimation and modulation/coding scheme order selection, downlink precoding generation in TDD, and the like based on the information.

As shown in FIG. 2, a manifold-based channel estimation method 200 is first described. It is assumed that in a downlink MIMO scenario, a DMRS pattern is a conventional uniform mode (for example, NR DMRS Type II 2 Symbol), and UE learns of the DMRS pattern.

In S210, the UE sends channel estimation capability information to a network device.

Specifically, after initially accessing a cell, the UE needs to send the channel estimation capability information to the network device, to report a channel estimation capability of the UE.

After receiving the channel estimation capability information, the network device performs a corresponding indication based on a reporting result of the UE and conditions existing when a channel estimation indication is set to different values.

If the UE is capable of performing a manifold-based channel estimation policy/method, the network device indicates the UE to perform channel estimation by using the manifold method. Steps of channel estimation are as follows.

In S220, the network device sends a DMRS pattern to the UE. For example, the DMRS pattern is an NR DMRS Type II 2 symbol.

In S230, the network device sends a reference signal RS to the UE, where the reference signal is used to determine at least two channel vectors, and the at least two channel vectors include channel vectors s₀ and s₁.

The UE obtains, based on the DMRS pattern, the channel vectors s₀ and s₁ on a subcarrier on which the RS is located, to perform subsequent channel estimation.

In S240, the UE calculates channel interpolation parameter information.

In this embodiment of this application, the channel interpolation parameter information is vector parameters that are of s₀ and s₁ and that are related to a port and a frequency/time domain location of the RS.

In an example embodiment, the channel interpolation parameter information includes at least one of the following parameters:
(1) an included angle θ between s₀ and s₁;
(2) a propagation rotation included angle φ between s₀ and s₁; and
(3) one or more to-be-interpolated channel vector locations t between s₀ and s₁.

θ and φ are determined according to the following relational expressions:

$${s}_{0}^{H} {s}_{1} = cos ( θ ) \cdot {e}^{+ j ϕ}$$

H is a conjugation transposition symbol of a matrix, and j is an imaginary unit.

The foregoing formula may be equivalent to the following:

$$θ = a cos ( \vert {s}_{0}^{H} {s}_{1} \vert )$$

$$ϕ = a tan ( \frac{Im ( {s}_{0}^{H} {s}_{1} )}{Re ( {s}_{0}^{H} {s}_{1} )} )$$

Re(x) represents a real part of a complex number x, and Im(x) represents an imaginary part of the complex number x. acos(x) represents an arc cosine of x, and atan(x) represents an arc tangent of x.

In another example embodiment, the channel interpolation parameter information includes at least one of parameters α and β, and α and β are determined according to the following relational expressions:

$$α = ( cos ( t \cdot θ ) - cos ( θ ) \cdot \frac{sin ( t \cdot θ )}{sin ( θ )} ) \cdot {e}^{+ j ϕ \cdot t}$$

$$β = \frac{sin ( t \cdot θ )}{sin ( θ )} \cdot {e}^{+ j ϕ \cdot ( t - 1 )}$$

It should be understood that the channel vector location t is a location of one or more to-be-interpolated channel vectors in a frequency domain or a location of one or more to-be-interpolated channel vectors in a time domain.

In S250, the UE performs channel estimation.

Specifically, after calculating the channel interpolation parameter information, the UE may obtain a to-be-interpolated channel vector sₜ according to a geodesic formula, to complete channel estimation. The geodesic formula is as follows:

$${s}_{t} = {s}_{0} \cdot α ( θ , ϕ , t ) + {s}_{1} \cdot β ( θ , ϕ , t )$$

According to the foregoing method, manifold-based channel estimation can be completed. However, in an actual MIMO system, a receiver machine may be affected by factors such as a signal-to-noise ratio and channel non-ideality when calculating channel interpolation-related parameters. This reduces accuracy of channel estimation, affects data demodulation effect, and further reduces spectral efficiency of the MIMO system. In addition, the receiver machine may have a problem of insufficient computational power. In this case, this application proposes a channel estimation method. A transmitter machine calculates a channel interpolation parameter in advance and notifies the receiver machine of the channel interpolation parameter. This can save computational power of the receiver machine, improve channel estimation performance, and improve spectral efficiency of the MIMO system.

It should be understood that descriptions of specific scenarios in embodiments of this application are merely examples. In addition to the foregoing described application scenarios, the method provided in embodiments of this application is also applicable to an application scenario in which a similar problem exists.

In the descriptions of embodiments of this application, unless otherwise stated, “a plurality” or “a plurality of” means two or more than two. In addition, “at least one” may be replaced with “one or more”.

Ordinal numbers such as “first” and “second” in embodiments of this application are intended to distinguish between a plurality of objects, but are not intended to limit sizes, content, an order, a time sequence, priorities, importance degrees, or the like of the plurality of objects. For example, first indication information and second indication information may be same information, or may be different information. In addition, such names do not indicate that content, sizes, application scenarios, transmit ends/receive ends, priorities, importance degrees, or the like of the two pieces of information are different. In addition, step numbers in embodiments described in this application are merely intended to distinguish between different steps, but are not intended to limit a sequence of the steps.

The technical solutions provided in embodiments of this application may be applied to wireless communication between communication devices. The wireless communication between the communication devices may include wireless communication between a network device and a terminal, wireless communication between network devices, and wireless communication between terminals. In embodiments of this application, the term “wireless communication” may also be referred to as “communication” for short, and the term “communication” may also be described as “data transmission”, “information transmission”, or “transmission”.

It should be understood that names of all nodes and information in this application are merely names specified for ease of description in this application, and may be different in an actual network. It should not be understood that the names of all the nodes and the information are limited in this application. On the contrary, any name that has a function that is the same as or similar to that of the node or the information used in this application is considered as a method or an equivalent replacement in this application, and falls within the protection scope of this application.

The following describes in detail a plurality of communication methods provided in embodiments of this application with reference to the accompanying drawings.

It should be understood that step numbers in embodiments of this application are merely used for description, and do not limit a sequence of steps.

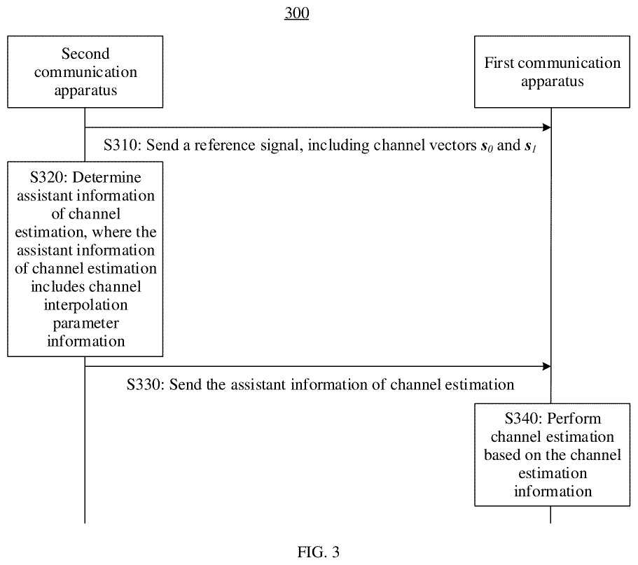

FIG. 3 shows a communication method 300 according to this application. Channel estimation is performed by using the method. A first communication apparatus is a receiver machine, and needs to perform channel estimation. The method in FIG. 3 includes at least a part of the following content.
S310: A second communication apparatus sends a reference signal to the first communication apparatus, where the reference signal is used to determine at least two channel vectors, and the at least two channel vectors include channel vectors s₀ and s₁.
S320: The second communication apparatus determines assistant information of channel estimation, where the assistant information of channel estimation is used for channel estimation of the first communication apparatus.
S330: The second communication apparatus sends the assistant information of channel estimation to the first communication apparatus.
S340: The first communication apparatus performs channel estimation based on the assistant information of channel estimation.

According to the foregoing solution, to improve accuracy of channel estimation and improve spectral efficiency of a MIMO system, the second communication apparatus first calculates channel interpolation parameter information and sends the channel interpolation parameter information to the first communication apparatus. This improves channel estimation performance, improves data demodulation effect, and improves spectral efficiency of the MIMO system.

The following describes S310 to S340 in detail.

In S310, the second communication apparatus sends the reference signal to the first communication apparatus, where the reference signal is used to determine the at least two channel vectors, and the at least two channel vectors include the channel vectors s₀ and s₁.

In embodiments of this application, the second communication apparatus and the first communication apparatus may be network devices, or may be terminal devices. For example, the second communication apparatus is a network device, and the first communication apparatus is a terminal device; or the second communication apparatus is a terminal device, and the first communication apparatus is a network device; or the second communication apparatus is a terminal device, and the first communication apparatus is a terminal device; or the second communication apparatus is a network device, and the first communication apparatus is a network device. A type of the communication apparatus is not limited in this application.

It should be understood that, when the second communication apparatus is a network device and the first communication apparatus is a terminal device, this corresponds to channel estimation in a downlink MIMO scenario; or when the second communication apparatus is a terminal device and the first communication apparatus is a network device, this corresponds to channel estimation in an uplink MIMO scenario.

After the second communication apparatus sends the RS to the first communication apparatus, the first communication apparatus obtains the channel vectors s₀ and s₁ on a subcarrier on which the RS is located, to perform subsequent channel estimation.

Optionally, the channel vectors s₀ and s₁ are channel vectors that are adjacent in a frequency domain or a time domain.

In an example embodiment, the first communication apparatus may obtain, based on a DMRS pattern, the channel vectors s₀ and s₁ on the subcarrier on which the RS is located. The DMRS pattern may be notified by the second communication apparatus to the first communication apparatus in advance, or may be preconfigured.

It should be understood that the reference signal may be a DMRS, an SRS, a CSI-RS, or the like. This is not limited in this application.

In S320, the second communication apparatus determines the assistant information of channel estimation, where the assistant information of channel estimation is used for channel estimation of the first communication apparatus.

The assistant information of channel estimation includes channel interpolation parameter information of the two channel vectors s₀ and s₁.

The second communication apparatus determines the assistant information of channel estimation. In other words, the second communication apparatus needs to calculate the channel interpolation parameter information.

In this embodiment of this application, the channel interpolation parameter information is vector parameters that are of s₀ and s₁ and that are related to a port and a subcarrier frequency/time domain location of the RS.

In an example embodiment, the channel interpolation parameter information includes at least one of the following parameters:
(1) an included angle θ between s₀ and s₁;
(2) a propagation rotation included angle φ between s₀ and s₁; and
(3) one or more to-be-interpolated channel vector locations t between s₀ and s₁.

θ and φ are determined according to the following relational expressions:

$${s}_{0}^{H} {s}_{1} = cos ( θ ) \cdot {e}^{+ j ϕ}$$

H is a conjugation transposition symbol of a matrix, and j is an imaginary unit.

The foregoing formula may be equivalent to the following:

$$θ = a cos ( \vert {s}_{0}^{H} {s}_{1} \vert )$$

$$ϕ = a tan ( \frac{Im ( {s}_{0}^{H} {s}_{1} )}{Re ( {s}_{0}^{H} {s}_{1} )} )$$

Re(x) represents a real part of a complex number x, and Im(x) represents an imaginary part of the complex number x. acos(x) represents an arc cosine of x, and atan(x) represents an arc tangent of x.

In another example embodiment, the channel interpolation parameter information may be a parameter further determined based on one or more of the parameters t, 0, and φ.

For example, the channel interpolation parameter information includes at least one of parameters α and β, and α and β are determined according to the following relational expressions:

$$α = ( cos ( t \cdot θ ) - cos ( θ ) \cdot \frac{sin ( t \cdot θ )}{sin ( θ )} ) \cdot {e}^{+ j ϕ \cdot t}$$

$$β = \frac{sin ( t \cdot θ )}{sin ( θ )} \cdot {e}^{+ j ϕ \cdot ( t - 1 )}$$

It should be understood that the channel vector location t is a location of one or more to-be-interpolated channel vectors in a frequency domain or a location of one or more to-be-interpolated channel vectors in a time domain.

In an example embodiment, when the channel vector location t represents a frequency domain location, t may be represented by a sequence number of a subcarrier.

FIG. 4 is a diagram of a channel. Each grid represents one frequency domain location (for example, one subcarrier), and each subcarrier corresponds to one channel vector.

For example, channel vectors s₀ and s₁ on an SC #0 and an SC #12 are known, and channel vectors on an SC #1 to an SC #11 need to be interpolated. It is assumed that the channel vectors are arranged at an equal step of the subcarriers.

$$t = \frac{1}{12} , \frac{2}{12} , ... , \frac{11}{12}$$

For example, when there are 24 ports, a frequency domain density of each DMRS port is 1 RE/1 RB, a bandwidth is 273 RBs, and each port has 273 REs in the full bandwidth. If precision is 8 bits, a total of 4352 bits are required for the parameters θ and φ in the full bandwidth of each port (without any compression method).

When the channel vector location t represents the frequency domain location, the assistant information of channel estimation is related to a frequency domain location of a subcarrier. In this case, the second communication apparatus and the first communication apparatus may agree on a frequency domain granularity of the RS.

For example, when the second communication apparatus is a network device, and the first communication apparatus is a terminal device, the network device may determine a frequency domain granularity and indicate the frequency domain granularity to the terminal device.

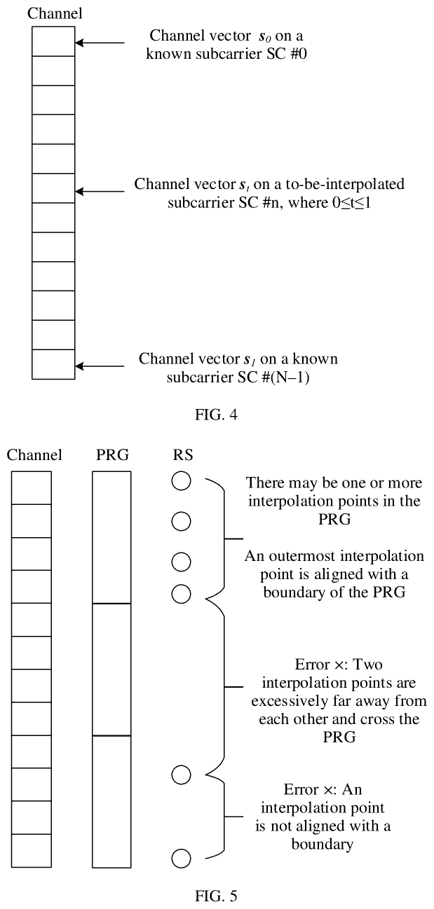

In this embodiment of this application, the frequency domain granularity is determined. As shown in FIG. 5, it needs to be ensured that there are at least two known channel vectors in one PRG, and there may be one or more interpolation points between the two channel vectors, and a boundary of the interpolation point is aligned with a boundary of the PRG.

It should be noted that, to ensure channel estimation performance, two nearest interpolation points do not need to be excessively far away from each other, and should not cross the PRG.

In another example embodiment, when the channel vector location t represents a time domain location, t may be represented by a sequence number of an OFDM symbol.

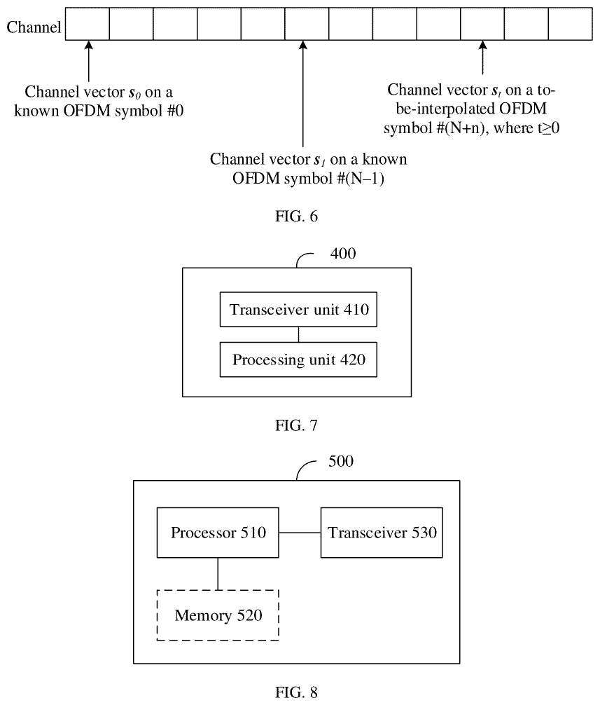

FIG. 6 is a diagram of a channel. Each grid represents one time domain location (for example, one OFDM symbol), and each OFDM symbol corresponds to one channel vector.

For example, channel vectors on an OFDM symbol #0 and an OFDM symbol #6 are known, and channel vectors on an OFDM symbol #8 to an OFDM symbol #11 need to be interpolated. It is assumed that the channel vectors are arranged at an equal step of the subcarriers.

$$t = \frac{8}{6} , \frac{9}{6} , ... , \frac{11}{6}$$

In the foregoing method, the second communication apparatus needs to calculate the channel interpolation parameter information. In this process, the second communication apparatus needs to obtain a channel of the RS in a frequency domain or a time domain, to determine the channel vector.

It should be noted that the foregoing description is merely an example. The location indicated by t, that is, a to-be-interpolated channel vector sₜ, may be a channel vector between s₀ and s₁, or may not be a channel vector between s₀ and s₁. This is not limited in this application.

In an example embodiment, the frequency domain channel or time domain channel is notified by the first communication apparatus to the second communication apparatus. For example, the second communication apparatus notifies the first communication apparatus of the frequency domain channel or time domain channel based on an SRS and/or a CSI-RS.

In an example embodiment, before the second communication apparatus sends the RS to the first communication apparatus, the first communication apparatus sends channel estimation capability information to the second communication apparatus, where the channel estimation capability information indicates a channel estimation capability of the first communication apparatus.

After receiving the channel estimation capability information, the second communication apparatus performs a corresponding indication based on a reporting result of the first communication apparatus and conditions existing when a channel estimation indication is set to different values.

In an example embodiment, the channel estimation capability information may indicate whether the first communication apparatus is capable of performing manifold-based channel estimation. If the first communication apparatus is capable of performing manifold-based channel estimation policy/method, the second communication apparatus indicates UE to perform channel estimation by using a manifold method.

In another example embodiment, the channel estimation capability information may indicate the channel estimation capability of the first communication apparatus, so that the second communication apparatus can determine the channel vectors s₀ and s₁ based on the channel estimation capability information, and further determine the channel interpolation parameter information between the channel vectors s₀ and s₁.

For example, it indicates that a spacing between the to-be-interpolated channel vector location t and the channel vectors s₀ and s₁ in a frequency domain or time domain needs to be less than a preset value; or it indicates that a spacing between channel vectors corresponding to θ and φ cannot be excessively short.

Specifically, when the channel vectors s₀ and s₁ are channel vectors that are adjacent in a frequency domain or a time domain, the channel vectors s₀ and s₁ may be excessively close to each other. Consequently, θ and φ of the channel vectors s₀ and s₁ do not meet a requirement of the channel estimation capability information. In this case, the second communication apparatus may determine two non-adjacent channel vectors in the reference signal as s₀ and s₁, and determine channel interpolation parameter information between the channel vectors s₀ and s₁.

The following describes an indication manner of the assistant information of channel estimation.

After the channel interpolation parameter information is determined, the network device may perform an indication in downlink control information (DCI), media access control signaling (MAC CE), or radio resource control (RRC) signaling based on changes of the parameters θ, φ, and t in a frequency domain or a time domain.

In an example embodiment, values of the parameters θ and φ depend on real-time channel vectors, and may be indicated in the DCI; and the parameter t changes slowly, and may be indicated in the MAC CE or RRC.

In S250, the UE performs channel estimation.

Specifically, after calculating the channel interpolation parameter information, the UE may obtain the to-be-interpolated channel vector sₜ according to a geodesic formula, to complete channel estimation. The geodesic formula is as follows:

$${s}_{t} = {s}_{0} \cdot α ( θ , ϕ , t ) + {s}_{1} \cdot β ( θ , ϕ , t )$$

FIG. 7 is a block diagram of a communication apparatus 400 according to an embodiment of this application. The apparatus 400 includes a transceiver unit 410 and a processing unit 420. The transceiver unit 410 may communicate with the outside, and the processing unit 420 is configured to perform data processing. The transceiver unit 410 may also be referred to as a communication interface or a communication unit.

In an example embodiment, the apparatus 400 may further include a storage unit. The storage unit may be configured to store instructions and/or data. The processing unit 420 may read the instructions and/or the data in the storage unit.

The apparatus 400 may be configured to perform an action performed by the base station in the foregoing method embodiments. In this case, the apparatus 400 may be the base station or a component that may be disposed in the base station. The transceiver unit 410 is configured to perform a receiving/sending-related operation on the base station side in the foregoing method embodiments. The processing unit 420 is configured to perform a processing-related operation on the base station side in the foregoing method embodiments.

Alternatively, the apparatus 400 may be configured to perform an action performed by the terminal device in the foregoing method embodiments. In this case, the apparatus 400 may be the terminal device or a component that may be disposed in the terminal device. The transceiver unit 410 is configured to perform a receiving/sending-related operation on the terminal device side in the foregoing method embodiments. The processing unit 420 is configured to perform a processing-related operation on the terminal device side in the foregoing method embodiments.

As shown in FIG. 8, an embodiment of this application further provides a communication apparatus 500. The communication apparatus 500 includes a processor 510. The processor 510 is coupled to a memory 520. The memory 520 is configured to store a computer program or instructions and/or data. The processor 510 is configured to execute the computer program or the instructions and/or the data stored in the memory 520, to perform the methods in the foregoing method embodiments.

In an example embodiment, the communication apparatus 500 includes one or more processors 510.

In an example embodiment, as shown in FIG. 8, the communication apparatus 500 may further include the memory 520.

In an example embodiment, the communication apparatus 500 may include one or more memories 520.

In an example embodiment, the memory 520 and the processor 510 may be integrated together, or disposed separately.

In an example embodiment, as shown in FIG. 8, the wireless communication apparatus 500 may further include a transceiver 530. The transceiver 530 is configured to receive and/or send a signal. For example, the processor 510 is configured to control the transceiver 530 to receive and/or send the signal.

In a solution, the communication apparatus 500 is configured to implement an operation performed by the base station in the foregoing method embodiments.

For example, the processor 510 is configured to implement a processing-related operation performed by the base station in the foregoing method embodiments, and the transceiver 530 is configured to implement a receiving/sending-related operation performed by the base station in the foregoing method embodiments.

In another solution, the communication apparatus 500 is configured to implement an operation performed by the terminal device in the foregoing method embodiments.

For example, the processor 510 is configured to implement a processing-related operation performed by the terminal device in the foregoing method embodiments, and the transceiver 530 is configured to implement a receiving/sending-related operation performed by the terminal device in the foregoing method embodiments.

An embodiment of this application further provides a communication apparatus 600. The communication apparatus 600 may be a terminal device or may be a chip. The communication apparatus 600 may be configured to perform an operation performed by the terminal device in the foregoing method embodiments. When the communication apparatus 600 is a terminal device, FIG. 9 is a simplified diagram of a structure of the terminal device. For ease of understanding and illustration, an example in which the terminal device is a mobile phone is used in FIG. 9. As shown in FIG. 9, the terminal device includes a processor, a memory, a radio frequency circuit, an antenna, and an input/output apparatus. The processor is mainly configured to: process a communication protocol and communication data, control the terminal device, execute a software program, process data of the software program, and the like. The memory is mainly configured to store the software program and data. The radio frequency circuit is mainly configured to: perform conversion between a baseband signal and a radio frequency signal, and process the radio frequency signal. The antenna is mainly configured to receive or send a radio frequency signal in a form of an electromagnetic wave. The input/output apparatus, for example, a touchscreen, a display, or a keyboard, is mainly configured to receive data input by a user and output data to the user. It should be noted that some types of terminal devices may have no input/output apparatus.

When data needs to be sent, the processor performs baseband processing on the to-be-sent data, and then outputs a baseband signal to the radio frequency circuit. The radio frequency circuit performs radio frequency processing on the baseband signal, and then sends a radio frequency signal to the outside in the form of an electromagnetic wave through the antenna. When data is sent to the terminal device, the radio frequency circuit receives the radio frequency signal through the antenna, converts the radio frequency signal into a baseband signal, and outputs the baseband signal to the processor. The processor converts the baseband signal into data, and processes the data. For ease of description, FIG. 9 shows only one memory and one processor. In an actual terminal device product, there may be one or more processors and one or more memories. The memory may also be referred to as a storage medium, a storage device, or the like. The memory may be disposed independently of the processor, or may be integrated with the processor. This is not limited in embodiments of this application.

In embodiments of this application, the antenna and the radio frequency circuit that have receiving and sending functions may be considered as a transceiver unit of the terminal device, and the processor that has a processing function may be considered as a processing unit of the terminal device.

As shown in FIG. 9, the terminal device includes a transceiver unit 610 and a processing unit 620. The transceiver unit 610 may also be referred to as a transceiver, a transceiver machine, a transceiver apparatus, or the like. The processing unit 620 may also be referred to as a processor, a processing board, a processing module, a processing apparatus, or the like.

In an example embodiment, a component that is in the transceiver unit 610 and that is configured to implement a receiving function may be considered as a receiving unit, and a component that is in the transceiver unit 610 and that is configured to implement a sending function may be considered as a sending unit. In other words, the transceiver unit 610 includes the receiving unit and the sending unit. The transceiver unit sometimes may also be referred to as a transceiver machine, a transceiver, a transceiver circuit, or the like. The receiving unit sometimes may also be referred to as a receiver machine, a receiver, a receive circuit, or the like. The sending unit sometimes may also be referred to as a transmitter machine, a transmitter, a transmit circuit, or the like.

For example, in an implementation, the transceiver unit 610 is configured to perform a receiving operation of the terminal device. The processing unit 620 is configured to perform a processing action on the terminal device side.

It should be understood that FIG. 9 is merely an example rather than a limitation. The terminal device including the transceiver unit and the processing unit may not depend on the structure shown in FIG. 9.

When the communication apparatus 600 is a chip, the chip includes a transceiver unit and a processing unit. The transceiver unit may be an input/output circuit or a communication interface. The processing unit may be a processor, a microprocessor, or an integrated circuit integrated on the chip. The input circuit may be an input pin, the output circuit may be an output pin, and a processing circuit may be a transistor, a gate circuit, a trigger, various logic circuits, or the like. An input signal received by the input circuit may be received and input by, for example without limitation to, a receiver, and a signal output by the output circuit may be output to and transmitted by, for example without limitation to, a transmitter. In addition, the input circuit and the output circuit may be different circuits or may be a same circuit. In this case, the circuit is used as the input circuit and the output circuit at different moments.

An embodiment of this application further provides a communication apparatus 700. The communication apparatus 700 may be a base station or may be a chip. The communication apparatus 700 may be configured to perform an operation performed by the base station in the foregoing method embodiments.

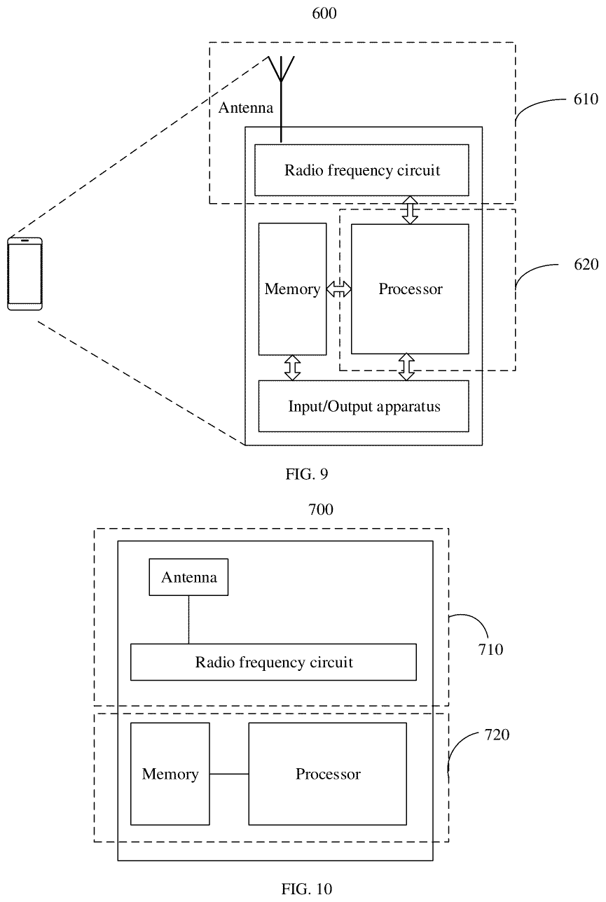

When the communication apparatus 700 is a base station, FIG. 10 is a simplified diagram of a structure of the base station. The base station includes a part 710 and a part 720. The part 710 is mainly configured to: receive and send a radio frequency signal, and perform conversion between the radio frequency signal and a baseband signal. The part 720 is mainly used for baseband processing, base station control, and the like. The part 710 may be usually referred to as a transceiver unit, a transceiver machine, a transceiver circuit, a transceiver, or the like. The part 720 is usually a control center of the base station, may usually be referred to as a processing unit, and is configured to control the base station to perform a processing operation on a network device side in the foregoing method embodiments.

The transceiver unit in the part 710 may also be referred to as a transceiver machine, a transceiver, or the like, and includes an antenna and a radio frequency circuit. The radio frequency circuit is mainly configured to perform radio frequency processing. In an example embodiment, in the part 710, a component configured to implement a receiving function may be considered as a receiving unit, and a component configured to implement a sending function may be considered as a sending unit. In other words, the part 710 includes the receiving unit and the sending unit. The receiving unit may also be referred to as a receiver machine, a receiver, a receive circuit, or the like. The sending unit may be referred to as a transmitter machine, a transmitter, a transmit circuit, or the like.

The part 720 may include one or more boards, and each board may include one or more processors and one or more memories. The processor is configured to read and execute a program in the memory, to implement a baseband processing function and control the base station. If there are a plurality of boards, the boards may be interconnected to enhance a processing capability. In an optional implementation, a plurality of boards may share one or more processors, or a plurality of boards share one or more memories, or a plurality of boards share one or more processors at the same time.

For example, in an implementation, the transceiver unit in the part 710 is configured to perform a sending/receiving-related step performed by the base station in the embodiment, and the part 720 is configured to perform a processing-related step performed by the base station.

It should be understood that FIG. 10 is merely an example rather than a limitation. The network device including the transceiver unit and the processing unit may not depend on the structure shown in FIG. 10.

When the communication apparatus 700 is a chip, the chip includes a transceiver unit and a processing unit. The transceiver unit may be an input/output circuit or a communication interface. The processing unit is a processor, a microprocessor, or an integrated circuit integrated on the chip. The input circuit may be an input pin, the output circuit may be an output pin, and a processing circuit may be a transistor, a gate circuit, a trigger, various logic circuits, or the like. An input signal received by the input circuit may be received and input by, for example without limitation to, a receiver, and a signal output by the output circuit may be output to and transmitted by, for example without limitation to, a transmitter. In addition, the input circuit and the output circuit may be different circuits or may be a same circuit. In this case, the circuit is used as the input circuit and the output circuit at different moments.

An embodiment of this application further provides a computer-readable storage medium. The computer-readable storage medium stores computer instructions used to implement the method performed by the terminal device or the method performed by the base station in the foregoing method embodiments.

For example, when a computer program is executed by a computer, the computer is enabled to implement the method performed by the terminal device or the method performed by the base station in the foregoing method embodiments.

An embodiment of this application further provides a computer program product including instructions. When the instructions are executed by a computer, the computer is caused to implement the method performed by the terminal device or the method performed by the network device in the foregoing method embodiments.

An embodiment of this application further provides a communication system. The communication system includes the base station and the terminal device in the foregoing embodiments.

For explanations and beneficial effect of related content of any wireless communication apparatus provided above, refer to the corresponding method embodiment provided above.

In embodiments of this application, the terminal device or the network device may include a hardware layer, an operating system layer running on the hardware layer, and an application layer running on the operating system layer. The hardware layer may include hardware such as a central processing unit (CPU), a memory management unit (MMU), and a memory (also referred to as main memory). An operating system at the operating system layer may be any one or more computer operating systems that implement service processing through a process, for example, a Linux operating system, a Unix operating system, an Android operating system, an iOS operating system, or a Windows operating system. The application layer may include applications such as a browser, an address book, word processing software, and instant messaging software.

A specific structure of an execution body of the method provided in embodiments of this application is not particularly limited in embodiments of this application, provided that communication can be performed according to the method provided in embodiments of this application by running a program that records code of the method provided in embodiments of this application. For example, the method provided in embodiments of this application may be performed by a terminal device or a base station, or may be performed by a functional module that is in the terminal device or the base station and that can invoke and execute a program.

Aspects or features in embodiments of this application may be implemented as a method, an apparatus, or a product that uses standard programming and/or engineering technologies. The term “product” used in this specification may cover a computer program that can be accessed from any computer-readable component, carrier, or medium. For example, a computer-readable medium may include but is not limited to a magnetic storage component (for example, a hard disk, a floppy disk, or a magnetic tape), an optical disc (for example, a compact disc (CD) and a digital versatile disc (DVD)), a smart card, and a flash memory component (for example, an erasable programmable read-only memory (EPROM), a card, a stick, or a key drive).

Various storage media described in this specification may represent one or more devices and/or other machine-readable media that are configured to store information. The term “machine-readable medium” may include, but is not limited to: radio channels and various other media capable of storing, containing, and/or carrying instructions and/or data.

It should be understood that, the processor mentioned in embodiments of this application may be a central processing unit (CPU), or may be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

It may be understood that the memory mentioned in embodiments of this application may be a volatile memory or a nonvolatile memory, or may include a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM). For example, the RAM may be used as an external cache. By way of example, and not limitation, the RAM may include the following plurality of forms: a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

It should be noted that when the processor is a general-purpose processor, a DSP, an ASIC, an FPGA or another programmable logic device, a discrete gate or a transistor logic device, or a discrete hardware component, the memory (a storage module) may be integrated into the processor.

It should further be noted that the memory described in this specification is intended to include but is not limited to these memories and any memory of another proper type.

A person of ordinary skill in the art may be aware that, in combination with the examples described in embodiments disclosed in this specification, units and algorithm steps can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of embodiments of this application.

It may be clearly understood by a person skilled in the art that, for ease and brevity of description, for a detailed working process of the foregoing system, apparatus, and unit, refer to a corresponding process in the foregoing method embodiment.

In the several embodiments provided in embodiments of this application, it should be understood that the disclosed system, apparatus and method may be implemented in another manner. For example, the described apparatus embodiments are merely examples. For example, division into the units is merely logic function division. There may be another division manner during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electrical form, in a mechanical form, or in another form.

The units described as separate parts may or may not be physically separate, and parts displayed as units may or may not be physical units, may be located in one place, or may be distributed on a plurality of network units. Some or all of the units may be selected based on actual requirements to achieve the objectives of the solutions in embodiments.

In addition, functional units in embodiments of this application may be integrated into one processing unit, each of the units may exist alone physically, or two or more units may be integrated into one unit.

When the functions are implemented in the form of a software functional unit and sold or used as an independent product, the functions may be stored in a computer-readable storage medium. Based on such an understanding, the technical solutions of embodiments of this application essentially, or the part contributing to the conventional technology, or a part of the technical solutions may be implemented in the form of a software product. The computer software product is stored in a storage medium, and includes several instructions for instructing a computer device (which may be a personal computer, a server, a network device, or the like) to perform all or some of the steps of the methods described in embodiments of this application. The foregoing storage medium includes any medium that can store program code, such as a USB flash drive, a removable hard disk, a read-only memory (ROM), a random access memory (RAM), a magnetic disk, or a compact disc.

The foregoing descriptions are merely non-limiting examples of specific implementations and are not intended to limit the protection scope, which is intended to cover any variation or replacement readily determined by a person of ordinary skill in the art. Therefore, the claims shall define the protection scope.

1. A channel estimation method, comprising:
receiving, by a first communication apparatus, a reference signal;
determining, by the first communication apparatus, at least two channel vectors based on the reference signal, wherein the at least two channel vectors comprise channel vectors s₀ and s₁;
receiving, by the first communication apparatus, assistance information for channel estimation from a second communication apparatus, wherein the assistance information for channel estimation comprises channel interpolation parameter information of the channel vectors s₀ and s₁; and
performing, by the first communication apparatus, channel estimation based on the channel interpolation parameter information.

2. The method according to claim 1, wherein the channel interpolation parameter information is vector parameters that are of the channel vectors s₀ and s₁ and that are related to a port and a frequency domain location of the reference signal, or the channel interpolation parameter information is vector parameters that are of the channel vectors s₀ and s₁ and that are related to a port and a time domain location of the reference signal.

3. The method according to claim 1, wherein the channel interpolation parameter information comprises at least one of: an included angle θ between the channel vectors s₀ and s₁, a propagation rotation included angle φ between the channel vectors s₀ and s₁, or one or more to-be-interpolated channel vector locations t.

4. The method according to claim 1, wherein the channel interpolation parameter information is determined based on parameters θ and φ, or based on parameters θ, φ, and t, wherein θ is an included angle between the channel vectors s₀ and s₁, φ is a propagation rotation included angle between the channel vectors s₀ and s₁, and t is one or more to-be-interpolated channel vector locations.

5. The method according to claim 3, wherein the one or more channel vector locations t are locations of one or more to-be-interpolated subcarriers in a frequency domain.

6. The method according to claim 5, wherein the one or more channel vector locations t are sequence numbers of the one or more to-be-interpolated subcarriers.

7. The method according to claim 3, wherein the one or more channel vector locations t are locations of one or more to-be-interpolated signals in a time domain.

8. A communication apparatus, comprising at least one processor; and one or more memories coupled to the at least one processor and storing instructions that, when executed by the at least one processor, cause the communication apparatus to:
receive a reference signal;
determine at least two channel vectors based on the reference signal, wherein the at least two channel vectors comprise channel vectors s₀ and s₁;
receive assistance information for channel estimation from a second communication apparatus, wherein the assistance information for channel estimation comprises channel interpolation parameter information of the channel vectors s₀ and s₁; and
perform channel estimation based on the channel interpolation parameter information.

9. The communication apparatus according to claim 8, wherein the channel interpolation parameter information is vector parameters that are of the channel vectors s₀ and s₁ and that are related to a port and a frequency domain location of the reference signal, or the channel interpolation parameter information is vector parameters that are of the channel vectors s₀ and s₁ and that are related to a port and a time domain location of the reference signal.

10. The communication apparatus according to claim 8, wherein the channel interpolation parameter information comprises at least one of: an included angle θ between the channel vectors s₀ and s₁, a propagation rotation included angle φ between the channel vectors s₀ and s₁, or one or more to-be-interpolated channel vector locations t.

11. The communication apparatus according to claim 8, wherein the channel interpolation parameter information is determined based on parameters θ and φ, or based on parameters θ, φ, and t, wherein θ is an included angle between the channel vectors s₀ and s₁, φ is a propagation rotation included angle between the channel vectors s₀ and s₁, and t is one or more to-be-interpolated channel vector locations.

12. The communication apparatus according to claim 10, wherein the one or more channel vector locations t are locations of one or more to-be-interpolated subcarriers in a frequency domain.

13. The communication apparatus according to claim 12, wherein the one or more channel vector locations t are sequence numbers of the one or more to-be-interpolated subcarriers.

14. The communication apparatus according to claim 10, wherein the one or more channel vector locations t are locations of one or more to-be-interpolated signals in a time domain.

15. A communication apparatus, comprising at least one processor; and one or more memories coupled to the at least one processor and storing instructions that, when executed by the at least one processor, cause the communication apparatus to:
send a reference signal to a first communication apparatus, wherein the reference signal is used to determine at least two channel vectors, and the at least two channel vectors comprise channel vectors s₀ and s₁;
determine assistance information for channel estimation, wherein the assistance information for channel estimation is used for channel estimation of the first communication apparatus, and the assistance information for channel estimation comprises channel interpolation parameter information of the channel vectors s₀ and s₁; and
send the assistance information for channel estimation to the first communication apparatus.

16. The communication apparatus according to claim 15, wherein the channel interpolation parameter information is vector parameters that are of the channel vectors s₀ and s₁ and that are related to a port and a frequency domain location of the reference signal, or the channel interpolation parameter information is vector parameters that are of the channel vectors s₀ and s₁ and that are related to a port and a time domain location of the reference signal.

17. The communication apparatus according to claim 15, wherein the determination of the assistance information for channel estimation comprises:
determining the channel interpolation parameter information, wherein the channel interpolation parameter information comprises at least one of: an included angle θ between the channel vectors s₀ and s₁, a propagation rotation included angle φ between the channel vectors s₀ and s₁, or one or more to-be-interpolated channel vector locations t.

18. The communication apparatus according to claim 15, wherein the determination of the assistance information for channel estimation comprises:
determining the channel interpolation parameter information, wherein the channel interpolation parameter information is determined based on parameters θ and φ, or based on parameters θ, φ, and t, wherein θ is an included angle between the channel vectors s₀ and s₁, φ is a propagation rotation included angle between the channel vectors s₀ and s₁, and t is one or more to-be-interpolated channel vector locations.

19. The communication apparatus according to claim 17, wherein the one or more channel vector locations t are locations of one or more to-be-interpolated subcarriers in a frequency domain.

20. The communication apparatus according to claim 19, wherein the one or more channel vector locations t are sequence numbers of the one or more to-be-interpolated subcarriers.
